(19) United States
(12) Patent Application Publication
(10) Pub. No.: US 2026/0032045 A1
(43) Pub. Date: Jan. 29, 2026

(54) CHRONOLOGICAL NETWORK DESIGN

(71) Applicant: HIRSCHMANN AUTOMATION AND CONTROL GMBH, Neckartenzlingen (DE)

(72) Inventor: Jonas GLASS, Riederich (DE)

(73) Assignee: HIRSCHMANN AUTOMATION AND CONTROL GMBH, Neckartenzlingen (DE)

(21) Appl. No.: 18/998,486

(22) PCT Filed: Jul. 21, 2023
(86) PCT No.: PCT/EP2023/070344

§ 371 Date: Jan. 25, 2025

(30) Foreign Application Priority Data
Jul. 25, 2022 (DE) 10 2022 118 523.0

(51) Int. Cl. H04L 41/0806; H04L 41/14

(52) U.S. Cl. CPC H04L 41/0806; H04L 41/145

(57) ABSTRACT

A method for configuring and subsequently operating a network in which at least two network devices are connected to one another via data connections may include a chronological sequence of parameterizable configuration steps is performed in a sequence carried out by a user, wherein these steps are stored sequentially on a timeline so that their presence and sequence on the timeline provides the necessary transparency in order to subsequently understand the intention and procedure of the configuration, in particular, of a network design.

The invention relates to a method for configuring and subsequently operating a network in which at least two, preferably significantly more than two, network devices are connected to one another via data connections, according to the features of the generic term of patent claim 1.

### STATE OF THE ART

Modern networks consist of a plurality of devices and network-wide configured technologies to implement continuously growing demands on networks. The resulting configuration is very complex and already entails problems with the network design. The network design process is iterative in nature, and each step entails more details and requirements for the network configuration. At present, the final network configuration is created by applying configuration steps until the desired result is achieved. In order to create the desired configurations using this method, expertise with a precise vision and the application of the configuration steps in the correct order are required.

### CHALLENGES

Applying this rather straightforward approach to the iterative process of network design entails some problems. This is because a configuration is continually being adapted until the end result is achieved. It becomes particularly problematic if the steps are not carried out in the correct order. The flexibility needed to implement changes to an existing configuration is very limited and often leads to unwanted side effects.

In particular, altering fundamental functionalities is very elaborate, as a lot of adjustment work is needed on the configurations that build on them. These changes often entail only temporary destructiveness. However, since this cannot be clearly represented in this approach, it means that other configurations have to be undone, only to be re-added afterwards with adjusted values. This increased effort for changes is expensive and prone to error. Since one is only confronted with the final configuration, the lack of transparency regarding the steps taken is an additional complicating factor, making it difficult to draw conclusions about the original intentions of the network design.

However, it is precisely the sequence and intention of the desired configuration steps that are the elementary data that arise in the network design process.

This invention describes another approach with the aim of optimally mapping the iterative process of network design. Instead of focusing on the configurations and their results, the new approach prioritizes the description of the path leading to them.

This is achieved by chronologically arranging the parameterizable configuration steps in the order in which they are taken by the user. These steps are placed sequentially on a timeline. Their presence and order on it initially provide the necessary transparency to retrospectively understand the intention and approach of a network design. Since it is no longer the end result that is stored, but the sequence of configuration steps, there is also significantly more flexibility. That is because the calculation of a configuration can now be recalculated at any time by sequentially processing individual steps. Any user input at any step can now be adjusted retrospectively. Likewise, the position of a step itself can be moved along the time axis. Fundamental changes, such as deleting and re-adding a device, which temporarily lead to a destructive end configuration, are now possible. Affected subsequent steps can either be automatically recalculated or visually indexed and adapted by the user to the new situation. This increased flexibility allows subsequent changes to be made with little effort. Analysis and export functions are now available for any configuration step due to the option of moving along the time axis. Thus, network designs can be better optimized and, for example, analyzed before or after a further configuration step. Furthermore, the elements on the timeline itself can also be added hierarchically in order to use scenarios such as subnets, complex user-defined templates or similar components.

The fact that a new or already existing configuration (also referred to as “the network design”) is now stored not as the final result but as a described path of configuration steps also offers advantages in the further processability of the data. The network design can now be applied to other databases and thus, for example, generate an even more precise configuration in a live system.

In this context, configuring means reconfiguring a network that is to be set up (and that has not been configured before) or changing an existing configuration of a network that has already been configured.

### APPLICATION IN AN EXAMPLE

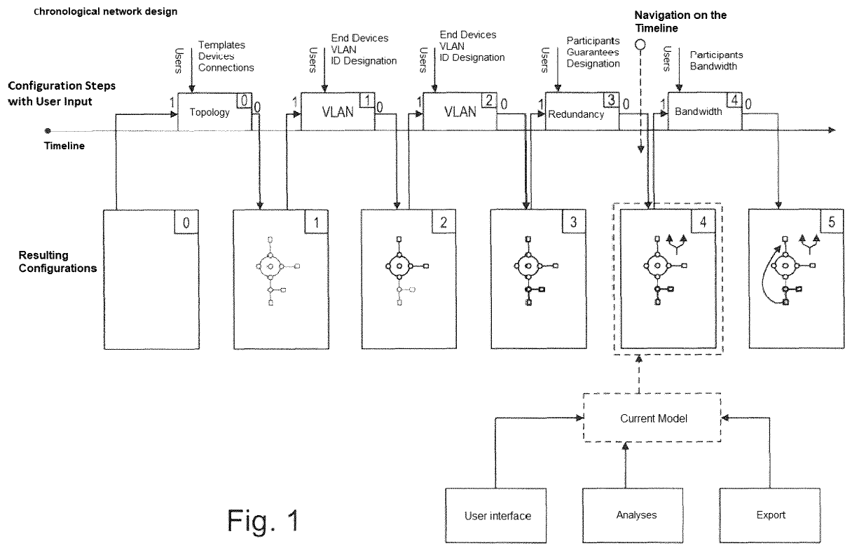

FIG. 1 shows the application of the chronological network configuration in a simple example. The timeline visualizes the configuration steps taken by the user in their order. It shows that the user first creates a topology with a parameterizable ring template and additional devices and connections. Subsequently, two VLANs are created with selected end devices and additional user input such as the name and a VLAN ID. Fourth, a redundancy and then a bandwidth reservation between two end devices is defined with the necessary user input.

The chronological design is based on the principle that each user-defined configuration step is calculated based on the result of a previous step and its result in turn serves as input for a subsequent step. In order to achieve a desired configuration state, the application can sequentially calculate the necessary steps to that point.

### Plotting and Depiction of Configuration Steps

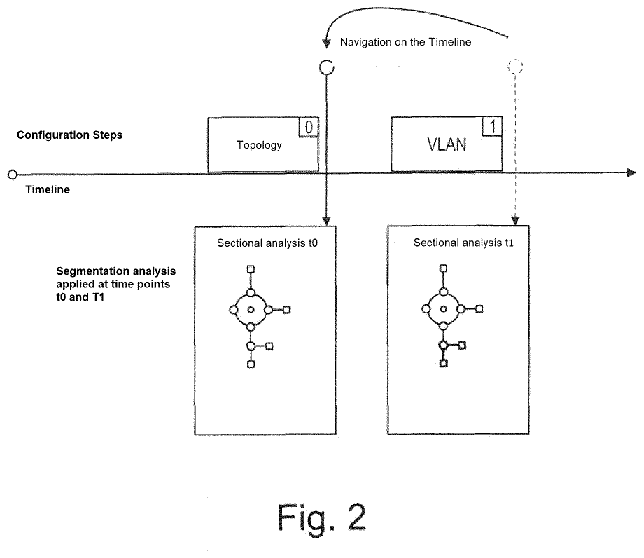

The plotting and depiction of the configuration steps is illustrated in FIG. 2. By sequentially plotting the configuration steps on the timeline, the user can now view the evolution of their network design, including intermediate results. This increases transparency and traceability, even for third-party users. Through the navigation option on the timeline, for example, analyses at different time points can be evaluated. This helps users to understand and optimize a network design.

### Changing Already Existing Configuration Steps

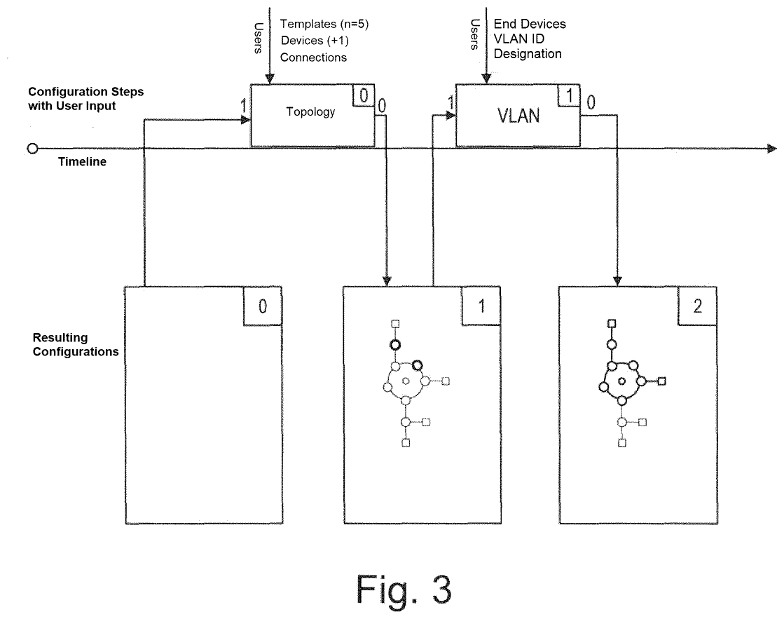

FIG. 3 shows how to change already existing configuration steps. Every taken configuration step can be adjusted by the user afterwards.

Therefore, the user input given during the creation can be altered.

Thus, FIG. 3 shows the subsequent change of the first step on the timeline. In the topology, the ring parameter was changed from 4 to 5 participants and an additional device was integrated. The affected configuration step itself, as well as all subsequent steps, are calculated by the application based on the new conditions and the resulting outcome is adapted. Thus, the subsequent VLAN is automatically extended by the newly added and, in this case, also affected devices.

### Subsequent Insertion of New Configuration Steps

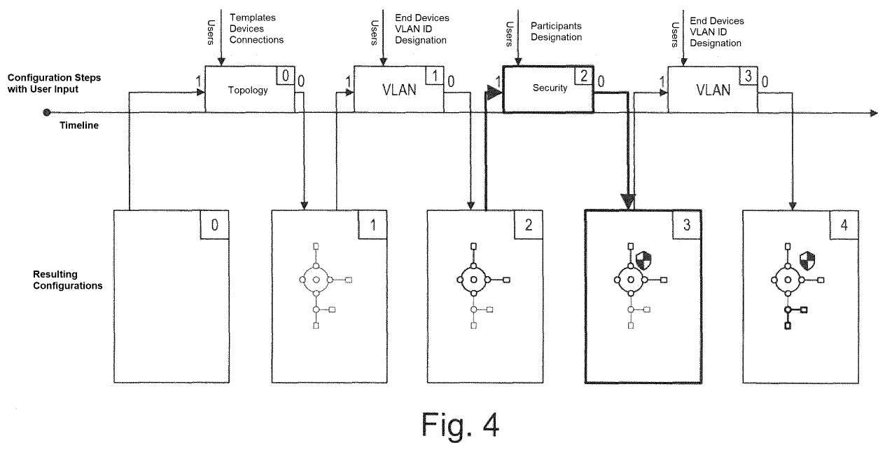

Configuration steps can also be inserted retrospectively between others, as illustrated in FIG. 4. The newly inserted step and all subsequent steps are recalculated based on the preceding steps. Thus, the new configuration step is included in the final result. Inserting a configuration step between the existing configuration steps of the VLAN is shown by way of example in FIG. 4. The subsequent VLAN is now calculated based on the result of the inserted security configuration step.

### Changing the Order of Configuration Steps

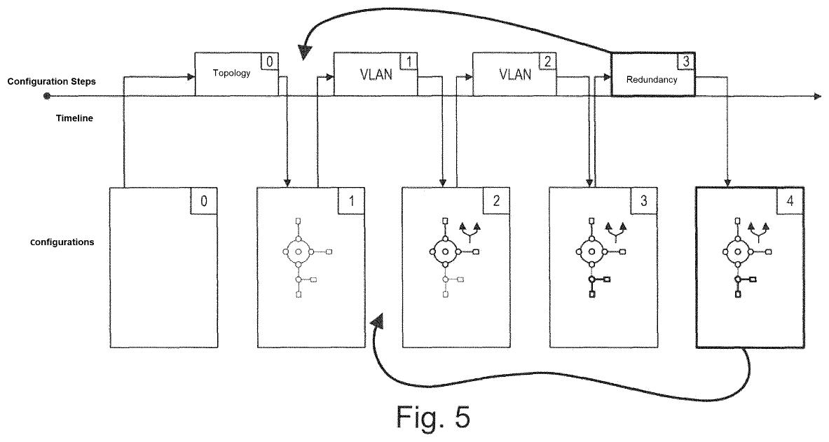

The user can also use the timeline to change the order of the configuration steps listed on it retrospectively, according to the illustration in FIG. 5. This means that a sequence of consecutive existing configuration steps is changed. In the example in FIG. 5, the last configuration step of the redundancy can be moved to the position after the topology creation. When the user does this, the system automatically recalculates the resulting configuration and creates the redundancy before the subsequent VLANs. The functionality of moving is particularly important for larger design changes.

### Deleting Already Existing Configuration Steps

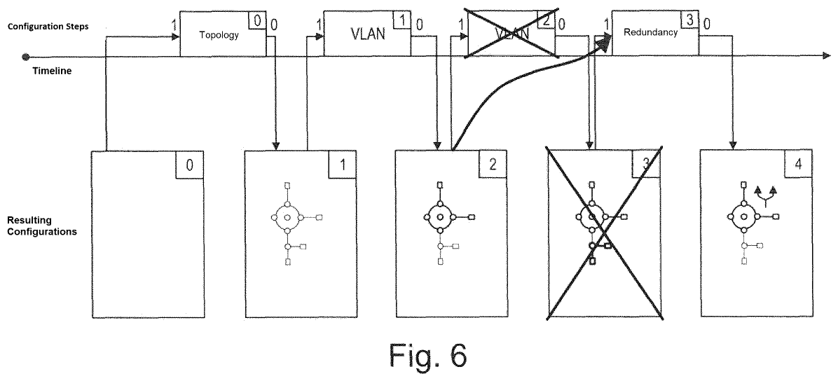

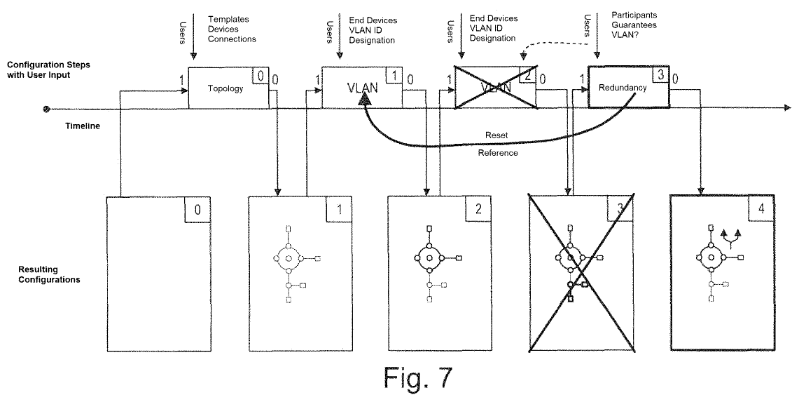

It is further provided that at least one configuration step is deleted from a sequence of at least two consecutive existing configuration steps. Deleting a basic configuration is one of the main problems of contemporary systems. This process is shown in FIG. 6. That is because deletion invalidates all subsequent configurations, which are then usually deleted by the application in a cascading manner and then have to be re-added by the user. With chronological design, the application can recalculate all subsequent steps after deletion and, in the best case, automatically repair the design without additional user interaction. As in the example in FIG. 6, an already created VLAN is deleted. The application now recalculates all subsequent configuration steps and can automatically calculate the adjusted end result in this case.

### Repairing Configuration Steps

It is also possible to repair configuration steps, as illustrated in FIG. 7.

However, the application cannot always repair the design without further input from the user. If there are direct dependencies on a deleted configuration step, these necessary references will be lost. The configuration steps affected by this can now be displayed to the user as damaged. This user then has the possibility to reset the lost reference and thus repair the network design efficiently, without a time-consuming redesign. In the previous example, a VLAN was deleted without any further dependencies and could thus be repaired automatically by the application. However, assuming that the subsequent redundancy block had a reference to the deleted VLAN as user input, it is now no longer automatically computable by the application due to the missing reference. In this case, the application marks the affected step as defective and offers the user the option of resetting the lost reference. This can be customized according to the user's preferences by referencing an existing or a subsequently added VLAN.

### Complex User Templates and Components

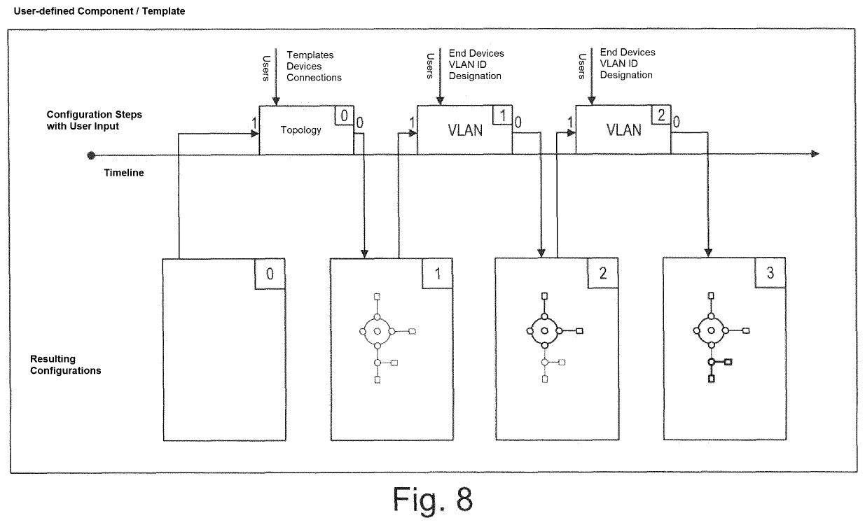

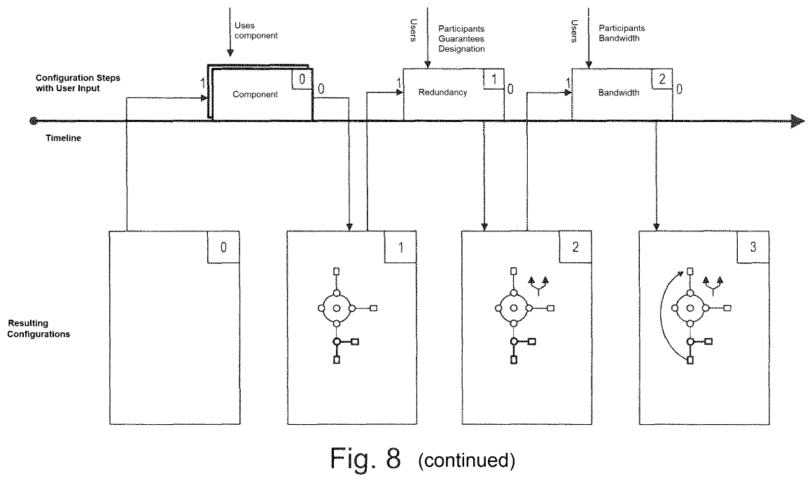

Some networks consist of similarly configured and frequently occurring subsegments. Therefore, for recurring configurations of a network or a subsegment of a network, it is possible to store a sequence of available configuration steps and use it as a template when configuring another network or another subsegment (subnetwork). It is therefore useful in this case for the user to be able to save complex templates as components so that they can be used repeatedly as a basis for variations. FIG. 8 shows a component created by a user consisting of a topology with two VLANs contained within it. This component can now be used, modified and expanded multiple times in the application. In this case, the user uses and expands the component to include redundancy and a bandwidth guarantee.

### Improved Processability

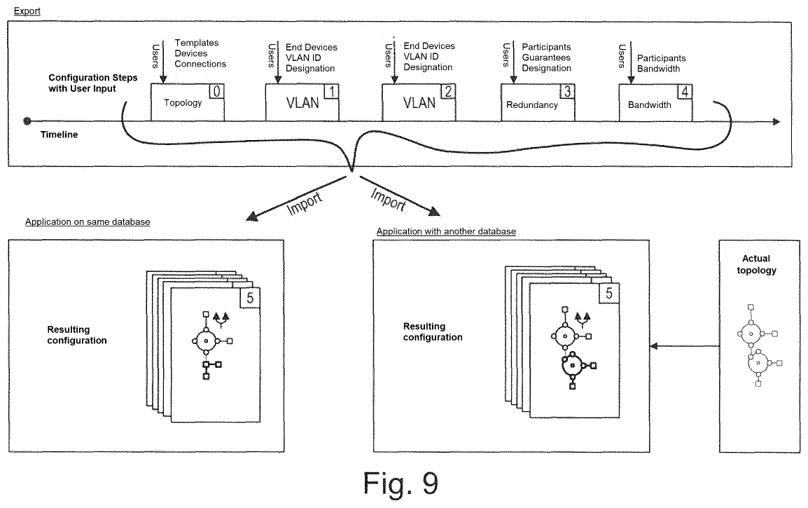

Since the principle of chronological modeling does not memorize the end result, but rather all the configuration steps taken by the user and their sequence, a resulting configuration can be recalculated over and over again. Thus, the timeline, including the configuration steps placed on it, can also be exported to other applications and calculated there. This is particularly advantageous when a virtually planned network design is transferred into reality and an adapted configuration is to be calculated based on the real topology. Due to the physical presence of the devices and connections, a calculation on real networks will always be more accurate than a purely virtually planned network because of the greater and higher-quality information content. Finally, FIG. 9 shows that slight deviations in the real world, such as the presence of additional devices and connections, can be taken into account and the desired configuration intentions can be automatically adapted and fulfilled.

1. A method for configuring and subsequently operating a network in which at least two, preferably significantly more than two, network devices are connected to one another via data connections, characterized by a chronological arrangement of configurable configuration steps in a sequence taken by a user, wherein these steps being sequentially placed on a timeline so that their presence and sequence thereon provide a necessary transparency for retrospectively reconstructing the intention and procedure during the configuration, in particular of a network design.

2. The method according to claim 1, wherein configuration steps are being plotted and/or depicted.

3. The method according to claim 1, wherein the existing configuration steps are changed.

4. The method according to claim 1, wherein the at least one new configuration step is inserted between two existing configuration steps.

5. The method according to claim 4, wherein the configuration of the network is determined on the basis of the inserted new configuration step and the sequence of the subsequently following existing configuration steps.

6. The method according to claim 1, wherein a sequence of successive existing configuration steps is changed.

7. The method according to claim 1, wherein the at least one configuration step is deleted from a sequence of at least two successive existing configuration steps.

8. The method according to claim 1, wherein an existing configuration step is repaired.

9. The method according to claim 1, wherein a sequence of available configuration steps is stored and used as a template when configuring another network.
